(19) United States
(12) Patent Application Publication
(10) Pub. No.: US 2006/0166174 A1
(43) Pub. Date: Jul. 27, 2006

(54) Predictive artificial intelligence and pedagogical agent modeling in the cognitive imprinting of knowledge and skill domains

(76) Inventors: T. Peter Rowe, Portland, OR (US); Dean Gordon Arrasmith, Aurora, OR (US); Deme Michael Clainos, Lake Oswega, OR (US)

Correspondence Address: Deme M. Clainos;StudyDog, 9720 SW Nimbus Ave., Beaverton, OR, 97008, US

(21) Appl. No.: 11/040,632

(22) Filed: Jan. 21, 2005

(51) Int. Cl. G09B 17/00; G09B 19/00

(52) U.S. Cl. 434/236

(57) ABSTRACT

System and methods for predicting and dynamically adapting the most appropriate content and teaching strategies that aid individual student learning. System and methods are based on a cognitive model that integrates new information with what the student already knows. A program of study is predicted by the unique cognitive needs of the individual student correlated with aggregated student data history using an Artificial Intelligence Engine (AI Engine). Said system and methods then dynamically adapt the initial cognitive model to the student's ongoing progress using personalized software Agents. Said system and methods include a computer network that incorporates a server-side AI Engine and a collection of client-side software Agents embodied as animated characters. The program connects new information to prior knowledge and then strengthens these connections through dedicated learning Activities, customized to the student, to ensure that effective, and real, learning occurs.

### CROSS REFERENCE TO RELATED PULICATION

This application claims the benefit of the U.S. Provisional Patent Application 60/538,030 with the filing date of Jan. 22, 2004.

| | | |
|---|---|---|
| 5761649 | June, 1998 | Hill |
| 5974446 | October, 1999 | Sonnenreich et al. |
| 5978648 | November, 1999 | George et al. |
| 6035283 | March, 2000 | Rofrano. |
| 6155840 | December, 2000 | Sallette |
| 6201948 | March, 2001 | Cook et al. |
| 6237035 | May, 2001 | Himmel et al. |
| 6321209 | November, 2001 | Pasquali. |
| 6343329 | January, 2002 | Landgraf et al. |
| 6356284 | March, 2002 | Manduley et al. |
| 6427063 | July, 2002 | Cook et al. |
| 6470171 | October, 2002 | Helmick et al. |
| 6,845,229 | Jan. 18, 2005 | Educational instruction system |

### BACKGROUND OF THE INVENTION

The use of technology in learning is still in its infancy but it has the potential to significantly impact our educational system in a positive way. Thus far, instructional technology has been mostly focused on visually presenting content organized in a mostly static way. This is understandable since a significant asset of the computer is that it is a medium-rich environment with features such as sound, movies, text, speech recognition, handwriting analysis, networked community environments, and multiplayer functionality that allow for the creation of a dynamic and exciting environment for the student. The difficulty has been harnessing the decision-making power of the computer to provide more effective learning environments. The realities of how these features are integrated into present-day computer-based instructional systems is generally simplistic: if a student incurs errors above a certain threshold in a certain area of study then they are deemed as lacking in that area and additional or alterative material is presented. Likewise if the student does exceptionally well in a specific activity or test then alternative, more difficult, material is presented. In general these systems start with each student as a new entity and address the presentation of instructional materials in a pragmatic way. In some cases these systems classify the relatively short-term progression history of the student and organize the sequence of instruction presentation on this basis. In other cases the program “adapts” to the child but typically this is a solution incorporating “fixed” content using simple branching logic. These are pragmatic solutions that make effective use of the computers visual and audio capabilities and concentrate more on presenting their content to the child, rather than letting the child's current state of intellect influence how and what is drawn to them.

Cognitive Science focuses on correlating instructional strategies and content with how the brain really works. Using a Cognitive Model as a basis for learning provides strategies more aligned with how receptive the brain is to receiving new information and how that information can be learned so that it is retained, and recalled later in a meaningful and useful way.

For example, learning to read is not an isolated skill and is much more involved than passive “decoding” skills. The cognitive model of reading is about the reader bringing their world experiences to bear on integrating new information with what they already know. Reading is not passive, it is active and the context depends very much on who the reader is. The same passage read by one reader may have a totally different meaning to another. Even very young readers engage many thought processes when reading such as predicting, categorizing, and making unexpected connections. At the same time they use strategies for comprehending words, sentences, and segments of text. Readers also make use of non-verbal clues from pictures, color, typography, and layout. In cognitive terms readers are active, selective, and strategic, they understand how and what they read in terms of what they already know, and they use many different thought processes in its execution. Many of today's computer-based learning systems are not interesting to the student because they do not operate within the same context, or world-view, in which the student resides. By relating to the cognitive needs of the student, programs can be created that align with their needs. Rather than force a specific top-down curriculum on the student, the program provides the student with what their learning needs require. This makes the program more effective in helping them learn, while providing a more enjoyable learning environment for the student.

### BRIEF SUMMARY OF THE INVENTION

The present invention is based around a “Cognitive Model” of each student. This cognitive model reflects the child's preferences and what they already know, and is initially built with data from external sources such as parental input, teacher input, student achievements, student questionnaires and testing. Some examples might include the sports or activities the student likes to play, the movies they may have seen, the stories they are familiar with, the hobbies they like most, the people they know.

The present invention incorporates a neural-net based Artificial Intelligence Engine (AI Engine) that discovers patterns between the cognitive model of a new student and the collective cognitive models of a population of previous students. In this way the AI Engine can initially predict the most effective program of study for a child based on its past experience with other students. It is this prediction data that is used to initially populate areas of the individual Student Cognitive Model, and to assign an initial program of study to new students. As more students use the system more data is available for the AI Engine to make more accurate predictions about new students.

In the present invention, as a student progresses through a program of study, wherein responses and results can be measured, a series of Intelligent Pedagogical Software Agents or “Agents” are assigned to, and learn more about, each individual student. The Agents fine-tune and adapt to the current, and ongoing, cognitive state of the student to provide real-time alignment to the best ways that skills are imprinted. In this way a distributed system of intelligent components is used to create and maintain a “virtual” cognitive model of each student. This learning environment begins with the best possible predicted course of study for each student based on his or her cognitive model and then learns how to fine-tune that environment to deliver a uniquely personalized program. Each program is based on the current and ongoing cognitive model of the student, and of the cognitive goals of the program. This results in learning by the most efficient and effective means for each student.

In the present invention the factors governing this learning process are based on the unique cognitive makeup and cognitive outcome requirements of each student. The rules of the system are directed at the highest level by the cognitive needs of the student and the cognitive goals of the program.

In the present invention, this system, as described, begins with the background data of the student's prior knowledge. Further information from the results of student tests is also incorporated. A predictive Artificial Intelligence Engine (AI Engine) then initializes a set of data in a cognitive model for the student. This model is patterned with previous aggregate student cognitive model data to identify an initial customized program of study for the individual student.

In the present invention, after the initial program of study is provided to the student, a set of software Agents refine and validate the predictions and further personalize the delivery of instruction for each student based on their unique current and ongoing cognitive state, and the goals of the program. The AI Engine thereby initially predicts data components of the cognitive model before the student begins a course of study while the Agents then dynamically adapt these predictions as new information is gained. The Agents negotiate to individualize the instructional program for each student even further by learning and adapting to how each student best responds to delivered instruction. This intelligence is returned to the AI Engine's collective data to allow for more accurate initial predictions for new students in the future. The Agents operate in real-time on behalf of each individual student and continually learn to identify and acquire the most effective, accurate, and up-to-date instructional material for that student based on their changing cognitive model. The entire system creates a contextual environment that maps to the cognitive state of the student thereby offering content and teaching strategies that are aligned with the student's ability to learn new information.

### BRIEF DESCRIPTIONS OF THE DRAWINGS

FIG. 1 shows the components of a research based cognitive learning model and how new information is integrated with prior knowledge, and how though learning the new information is integrated as part of the knowledge pool, or modifies what is already in the pool.

FIG. 2 shows the implementation of the Student Model that incorporates the Cognitive Model of the Students Prior Knowledge Network, the Assessment Results, the Lessons Task Models/Results, and the Student Concept Map.

FIG. 3 shows the external relationships that can impact the learning state of the Student Cognitive Model. These consist of Prior Knowledge, Culture, the AI Engine, the Predictive Classifier, Parents & Teachers, and the Agents.

FIG. 4 shows the architecture of the Agents interfacing with the Learning Environment. This interface is carried out through a single unit called the Agent Control Module that in turn interfaces with the Domain Knowledge, the Cognitive Model, the Pedagogical Session Model, and the Agent Appearance and User Interface (UI) Module.

FIG. 5 shows the components of the Agent Behavioral Control Description. These include the Pedagogical Goals, The Potential Student Actions, The Agent Interventions, and the Student Concept Database.

FIG. 6 shows an overall high-level architecture of the system. In the top section this shows the Student Cognitive Model and how the Lesson and Assessment Results along with the Concept Map of cognitive goals, and the Student profile, all relate to provide the state of the Student Cognitive Model. The bottom section shows how the AI Engine aggregates information from a population of Student Cognitive Models to provide predictive data to the Student Model.

FIG. 7 shows the components of the Student Learning Profile divided into three sections: Skill Inventory, Personal Demographics, and Learning Preferences. These sections are further divided to show the Skill Inventory as being made up, for example, of the National Reading Panel Skills, Six-Traits for Writing, or NCTM Ten Math Areas, the Personal Demographics being made up of Student Age, Gender, Family Structure and Income, Special Needs, and the Learning Preferences being made up of the Preferred Learning Style(s) and Preferred Learning Environment

FIG. 8 shows the Skill Level Instructional Model. This begins with a Placement Test followed by a loop of Instruction, Modeling, and Practice that is tested with a Benchmark Test to identify the skill Range and to then teach new skills and reinforce prior skills.

FIG. 9 shows a framework of learning systems curriculum consisting of specific instructional knowledge and skill areas derived from the research literature. These areas describe, at a high level, student proficiency targets, taking into account age/grade and appropriate content.

FIG. 10 shows an implementation relation between a Server computer, which provides the software which implements the system and stores all the data, to multiple client computers that support Agents used by students. While some components of the system execute on the Client, all of these components initially reside on the Server Computer, and are acquired by the client. The server computer can service many clients over a network such as the Internet, or an internal network such as a Local Area Network (LAN).

### Tables

Table 1 illustrates the manner in which each of the modules of the Student Cognitive Model is impacted by the various data driven and intelligent components of the learning system.

TABLE 1
How Components of the Student Cognitive Model are impacted

| | Student | Lesson Task | Assessment | Student |
|---|---|---|---|---|
| | Cognitive Model | Models/Results | Results | Concept Map |
| Parents & | Enters initial | | May examine | May examine |
| Teachers | known | | through a | through a |
| | information | | reporting | reporting |
| | | | interface. | interface. |
| Machine | Consumes known | Consumes | Consumes | |
| Learning | portions of student | lesson results as | assessment | |
| Engine | profiles as training | training data to | results as | |
| | data to build | build predictive | training data to | |
| | predictive | classifier. | build predictive | |
| | classifier | | classifier. | |
| Predictive | Uses known | May predict | May predict | |
| Classifier | portions of student | lesson results. | assessment | |
| | profile as input to | | results. | |
| | predict unknown | | | |
| | information about | | | |
| | the student. Will | | | |
| | predict some | | | |
| | initially unknown | | | |
| | elements of | | | |
| | student profile. | | | |
| Instructional | | Records lesson | May use to | Records |
| Agents | | task model and | assist with | observed |
| | | results and uses | customization | student |
| | | them to shape | of instructional | concepts and |
| | | instructional | level. | certainty |
| | | customization | | values, and |
| | | in each agent's | | uses these to |
| | | individual | | shape |
| | | lesson. | | customization |
| | | | | in each agent's |
| | | | | Lesson. |
| StudyDog | Uses Student | Uses lesson | Uses | Uses student |
| Agent | Cognitive Model to | results in lesson | assessment | concept map in |
| | customize lesson | selection and | results in lesson | lesson |
| | plan. May also use | intervention to | selection. | selection. |
| | information in | change lessons | | |
| | student profile to | midstream. | | |
| | guide the ways in | | | |
| | which the Helper | | | |
| | Agent interacts with | | | |
| | the student. | | | |

### DETAILED DESCRIPTION OF THE INVENTION

Cognitive Learning Models

The present invention is aligned with modern theories about how the brain learns. Instead of a strategy of “one size fits all” classroom presentations and basic teaching techniques such as the decoding component of reading, new information is introduced into a context of what the student already knows. This “integration” of new information with prior knowledge results in comprehension. For example information about a particular game is incomprehensible to someone lacking prerequisite knowledge about the game but is easily comprehended by someone who knows the rules and strategies of play.

However, comprehension does not mean learning has occurred. For learning to occur the connection between new information and prior knowledge must be strengthened by activities to the extent that the new information becomes a part of, or modifying, the existing knowledge. Therefore learning takes place when new information becomes part of existing knowledge. Beyond learning is that the new information now integrated into the existing knowledge base is meaningful and useful. Knowledge is “meaningful” only after it is richly interconnected with related knowledge. Knowledge is “useful” only if you can access it under appropriate circumstances. Meaningful knowledge is filed and cross-referenced with other knowledge to which it is connected. Useful knowledge is filed and cross-referenced so that you can find it when you need it.

Once new information is learned and the knowledge exists the issue now becomes how can it be a retrieved and acted upon at a later date. The brain does not appear to store data in a linear manner; it appears to be a network of connections to relevant information. Once one piece of information is accessed other relevant pieces then become available. This information generally isn't stored with perfect accuracy; the brain appears to be able to reconstruct a good “interpretation” of the information it already has. The brain can even “remember” things it never learned by inferring from the information it already knows.

Cognitive Imprinting Of Knowledge And Skill Domains

The knowledge and skills associated with reading, writing, and mathematics have existed for the past 4,000 to 5,000 years—a very short time in terms of human evolution. Only within the past few centuries have many people become literate in these areas of thought and activity. While many human attributes, such as speech and counting, have evolved much earlier and are now naturally learned systems in the human brain, the skills and knowledge associated with reading, writing, and mathematics have to be specifically taught and learned. Without specific instruction and practice, these domains will likely not be manifested in humans.

Unlike innate skills, the human brain must be imprinted with the knowledge and skills from these domains, and neurological networks established and strengthened through repetitive practice to achieve proficiency. Neuroscientists recognize that as these skills and knowledge develop they involve several brain areas associated with visual recognition, memory, language processing, speech, semantic understanding, and higher-order processing. Some neuroscientists believe in a deeper cognitive processing that forms the meta-cognition that is required to proficiently employ these learned domains. Several brain sites must act in harmony, in neuro-networks, for proficiency in these knowledge and skill domains. Some of these sites rely on secondary use of the cortical areas of the brain to do jobs that they were not originally intended to do, a phenomenon identified by Darwin as a conversion of function in anatomical continuity.

In order for the brain to develop the new functional centers and to form and strengthen the neural-networks between the centers, knowledge and skill must be carefully sequenced and explicitly taught to build a scaffolding to support increasingly higher-order activities. Basic, prerequisite skills must be sufficiently developed and made automatic to allow cognitive attention for meta-cognitive activities such as higher-order comprehension, control of language and meaning, and inferential mathematical reasoning, for examples. Basic and automatic understanding of letter and sound associations, writing mechanics, and number-word associations are required to develop higher order knowledge and skills in reading, writing, and mathematics, respectively.

The present invention learning system embodies these concepts within the framework of a Student Cognitive Model using artificial intelligence sub-systems and software Agents to deliver instruction of uniquely sequenced and recursive knowledge and skills domains.

The present invention uses technology to teach students how to read based on the above cognitive model. The description below describes this in detail.

FIG. 1 shows a cognitive learning model where the connection of new information and prior knowledge lead to comprehension. Activities that strengthen this connection are shown as “Elaboration” by which real learning occurs as connections are strengthened and new information is added to the prior knowledge network. The present invention implements this model by initially creating a Prior Knowledge database for each student. This information, in combination with information inferred by the AI Engine based on the history of past students, and the student test and questionnaire results are is used to initially create a customized course of study for the student

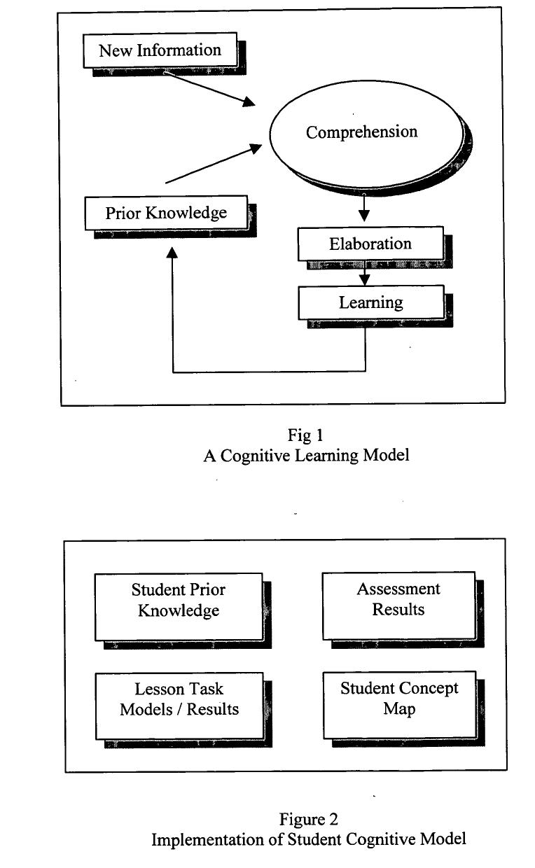

FIG. 2 shows the Student Cognitive Model for the present invention learning system. This Student Cognitive Model represents all the student information that the system can use to customize the learning experience on a per-student basis. This Student Cognitive Model is used, and contributed to by the AI Engine, the Helper and Content Agents, input from a parent and teacher, and by student knowledge information from other sources. The Student Cognitive Model is comprised of a number of modules which we will now describe:

The ‘Student Cognitive Model” is the implementation of the students cognitive state and contains the initial student profile as input by parents and teachers, the student's learning style information, and a knowledge base of any other general information where the system might learn about what the student already knows.

The ‘Lesson Task Model/Results’ module represents essentially what the present invention learning system tracks on a per-lesson basis—where the student has progressed to in a particular lesson, difficulties they have had, time spent, number of correct responses, etc. Each task model would continue to be built on a lesson-by-lesson basis, depending on the structure and needs of each lesson.

The ‘Assessment Results’ module contains the results of any assessment instruments applied outside the context of a lesson (any kind of pre-tests or post-tests, for example).

Finally, the ‘Student Concept Map’ module contains a partially ordered set of “concept nodes”, where each concept node represents one of the abstract concepts that the lessons teach to the student. Each concept node contains a numeric rating of the student's mastery of that concept, and references to lesson entries in the Lesson Task Models/Results module which provide evidence for those ratings. One goal of the AI Engine is to be able to predict values for some of the information in the Student Cognitive Model. All information that can be predicted is tagged with a certainty rating. A certainty rating of −1 means no information is known about the data, while a certainty rating between 0 and 1 means some information is known (with 0 meaning the value is based purely on a predictive model and 1 meaning that the value is known as fact). For example, the AI Engine might predict that a student is a visual learner. At this point, the student's learning style would initially have a certainty value of 0. As the student works within the learning system, the system gathers additional evidence (the student's performance on lessons designed for a visual learning style) to confirm or modify that predictive classification. The more consistent evidence the system gathers, the higher the certainty rating becomes.

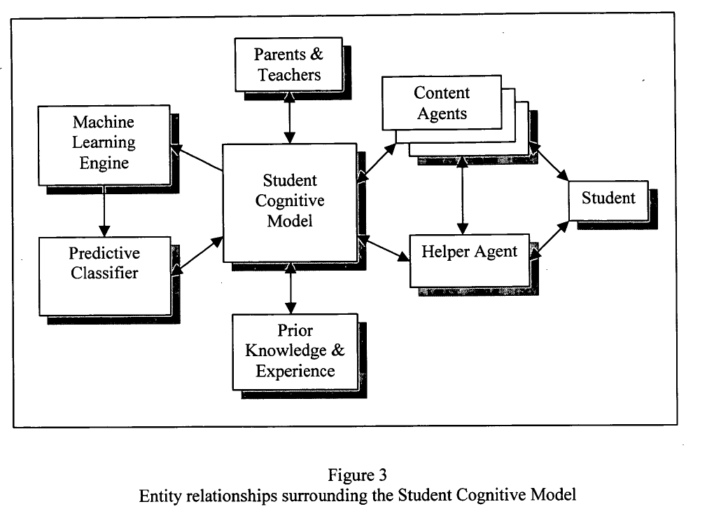

FIG. 3 illustrates how the Student Cognitive Model resides at the core of the present invention learning system. By being a repository of information about the student, what the already know, and his or her progress within the learning environment, the Student Cognitive Model facilitates asynchronous communication between the predictive AI Engine, the Agents, and the student's parents and/or teachers. The Student Cognitive Model incorporates the currently known cognitive state of the student. For example, if the student's prior knowledge information indicates that the student is interested in sports, then activities that relate to sports and games are preferred. Table 1 illustrates the manner in which each of these entities makes use of and/or contribute to the Student Cognitive Model.

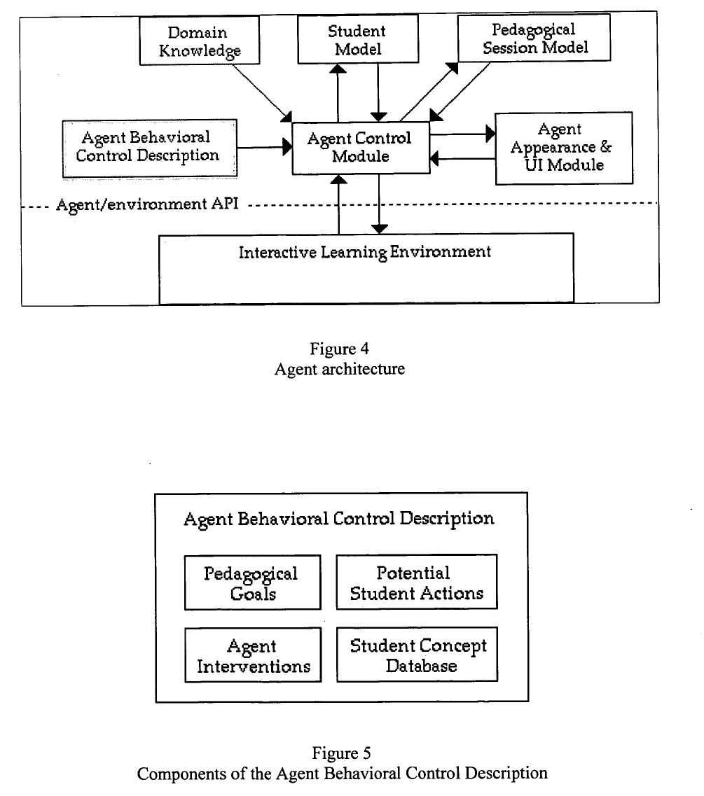

FIGS. 4 and 5 show the Agent architecture and how it interfaces to the learning environment through an Application Programming Interface (API). In this architecture, the agent is very modular and is not tightly integrated with the learning environment at all—in fact, it only communicates with the learning environment through a well-defined interface. It is built around the Agent Control Module, which is responsible for processing events received from the learning environment, updating its student and session models based on those events, initiating interactions with the student, and potentially sending commands back to the learning environment. The appearance and user interface (UI) aspects of the agent have been separated out into a distinct module. This allows for maximum flexibility in the appearance of the agent. Either the agent can appear in its own window, or the learning environment itself can implement this module, allowing the agent to appear within the main window of the environment, as is the case with the present invention agents. This architecture is very flexible as shown in being able to relax the architectural separation between the agent and the learning environment. In this way the Content Agents are not required to be tied to those lessons and tightly integrated with them. However, even if the Agents are implemented in the same code as the lessons themselves, it is still useful to separate them on a conceptual level. Relaxing this architectural separation simplifies some of the Agent's work, as the Agent then has complete access to the state of the learning environment, rather than getting only the information disclosed through the Agent/environment API.

Domain knowledge is also tied directly to each Content Agent, and there is duplication of domain knowledge across the various Content Agents. For this reason there is also a knowledge base of domain knowledge separate from any one particular Agent.

Inside the Agent Behavioral Control Description, there are four categories of information—pedagogical goals, potential student actions, agent interventions, and the student concept database. ‘Pedagogical goals’ represent the general educational objectives of the Agent—for example, what concepts are most important for a student to learn, what learning style does the student prefers. ‘Potential Student Actions’ are exactly that—actions or (more often) classes of actions that the student may take within the learning environment. ‘Agent Interventions’ comprise all actions that the agent might take, such as giving the student a clue, explaining a concept, or adjusting the lesson content or goals.

The ‘Student Concept Database’ is the generic version of the student concept map we have already been discussing in the context of the Student Cognitive Model. It contains the concepts and their relationships, with none of the data regarding where a particular student is at in understanding the concepts.

The relationships between these four groups of entities in the Agent Behavioral Control Description are expressed in terms of declarative rules, such as, if the student performs potential student action X it is evidence that they have a misconception regarding concept Y and the Agent should take intervention Z.

The Agents base their actions on a Student Cognitive Model and task models that they construct via their interactions with the student and by observing the student's performance on multiple tasks in the learning environment. A Student Cognitive Model is a model of the student's cognitive state, relative to the educational subject area. It may also contain other information about the student, such as preferences, learning style, etc. Task models are generally somewhat simpler—they model the particular educational task the student is performing and how the student is progressing through that task.

The present invention learning system contains software Agents. The “Content” characters in each lesson can be seen as tutors or instructional Agents, while the Helper character personifies an Agent designed to shape and guide the student's overall learning experience, and to provide positive feedback response to the student. From an affective perspective, the Helper Agent also acts as the student's companion and “buddy” throughout the learning experience. The Helper Agent is in charge of lesson selection and providing assistance and encouragement to the student, while the Content Agents in each lesson are in charge of managing the presentation of the subject matter.

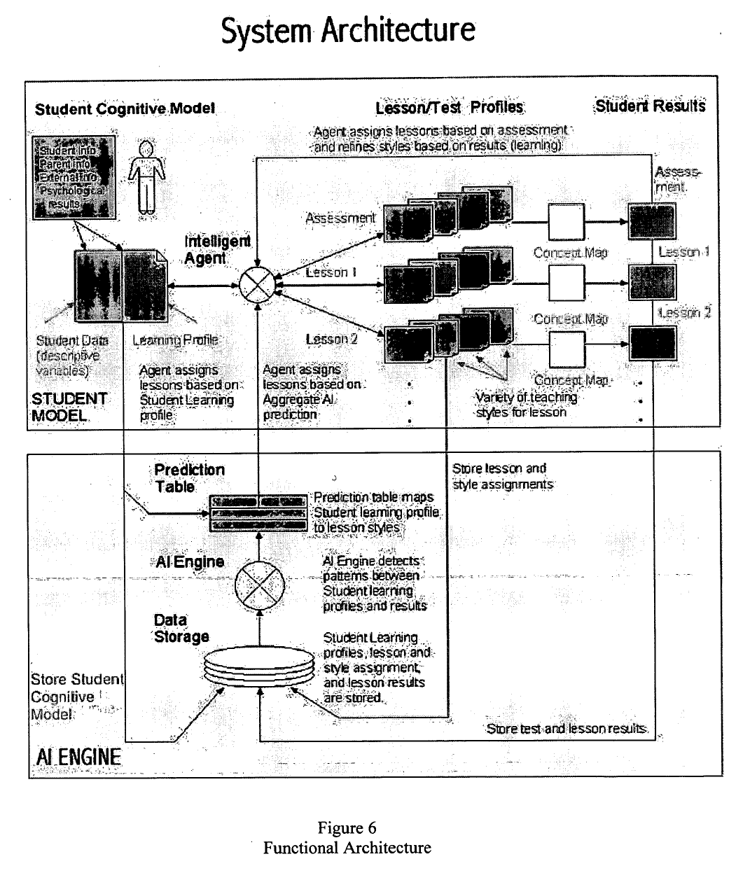

The drawing shown in FIG. 6 clearly identifies the two distinct modalities for the employment of AI techniques within the present invention. The first, identified in the figure as the “AI Engine” component, employs offline machine learning designed to use the Student Cognitive Model of existing students to automatically learn classifiers which can then be used to classify new students according to their initial profiles along such axes as preferred stories, music, learning styles, attention spans, etc. This initial classification can then be used to provide the first level of lesson selection and customization for the new student. The second component, identified in the figure as “Student Cognitive Model”, shows the use of an interactive pedagogical Agent to monitor the student's progress and work on the student's behalf to provide customized guidance and lesson planning, based on the ongoing cognitive model and actual student performance within the learning system.

AI Engine

The AI Engine component of the present invention takes as input the ongoing cognitive models of existing students working through the system patterned against the cognitive model of new students. Its output is a classification system that is used to predict the best lessons to assign to the new students, given only their entrance cognitive state. Let's take a look at one example of how this works:

Suppose that a students profile shows that they have prior knowledge from watching movies, in particularly the Harry Potter movies. The system can now predict that questions about the movie can be answered with high success, and that presented material in the context of the movie will fit the cognitive model of the child. Using this information the student can be classified as one that benefits from storylines. By pairing the student's entrance cognitive model with this outcome a training example is made. This training example, along with the training example from other students, would be used by the AI Engine to product a general classifier.

As a second example suppose that a student did very well in lessons that were designed specifically for a visual learning style, but was less successful in similar lessons designed for other learning styles. We might classify this student as a primarily visual learner. This student's entrance cognitive state would then be paired with that classification to make a “training example”. That training example, along with the training examples from all other existing students in the system would then be provided to the AI Engine to produce an automated “classifier”. The classifier in this example would be a mapping from entrance cognitive models to learning styles. Once it has been created by the AI Engine, we give it the entrance cognitive model of a new student and it will predict what their learning style is. Generally, the more training examples we have when building the classifier, the more accurate the resulting classifier will be. To understand how the classifier is built we can see that it depends upon what machine learning algorithm is used and the specific relationships revealed from the data.

Machine learning techniques used in the present invention are known as “supervised” machine learning. The learning is said to be supervised because we, the “teachers”, are providing the system with a set of pre-classified training examples. This type of learning is also known as “inductive reasoning”, because the system knows no logical rules about how to classify students until it is given the training examples that it analyzes to “induce” a classification system. The data that we send to the classifier (in our case, a Student Cognitive Model) is known as an “input vector”.

Machine Learning AIgorithms

While “Decision tree algorithms” that analyze the training data they are given to produce a tree-structured classifier, and “Case-Based Reasoning algorithms,” that look for the “closest” previously seen example in a database and output the classification from that example, were considered for the present invention, an Artificial Neural Network (ANN) was chosen as the most appropriate machine-learning algorithm. It incorporates decision tree algorithms and case-based reasoning algorithms along with other logic-based systems in a complex network similar to human neural functions.

Knowledge And Skill Domains For Instruction

The framework of the present invention learning system curriculum consists of specific instructional knowledge and skill areas derived from the research literature (see FIG. 9). These areas describe, at a high level, student proficiency targets, taking into account age/grade appropriate content. Examples of these skill areas include the five areas of proficient reading identified by the National Reading Panel including phonemic awareness, phonics, vocabulary, fluency, and comprehension. The six-traits of effective writing provide a strong foundation for organizing writing instruction and collectively define writing proficiency. The writing traits include ideas, organization, voice, word choice, sentence fluency, and conventions. In mathematics, the National Teachers of Mathematics have defined ten school content areas including computation, algebra, geometry, measurement, data analysis and probability, problem solving, reasoning and proof, communication, connectionns, and representation. These areas are reflected at all levels of the proposed mathematics curriculum applied to grade and age-level appropriate content.

These knowledge and skill areas in the domains of reading, writing, and mathematics provide a framework for organizing and sequencing the instructional curriculum. Artificial intelligence sub-systems and Agents flexibly move students through the curriculum, considering the skill gaps, mastery retention, preferred learning styles, and other performance and demographic predictors of domain and content area development needs.

Critical Scope And Sequence

The scope and sequence of the present invention curriculum follows the instructional scaffolding of content area knowledge and skills, building increasingly complex ability. Throughout the curriculum, basic skills are introduced, taught explicitly, practiced and reinforced. Skill level performance is distributed throughout the curriculum in order to monitor student confidence and skill retention. The curriculum was developed with the following points of guidance:

Appropriate grade or age-level content at each level of the curriculum

The knowledge and skill order within each level of the curriculum

Curriculum scaffolding for introducing, explicitly teaching, practicing and retaining knowledge and skill mastery

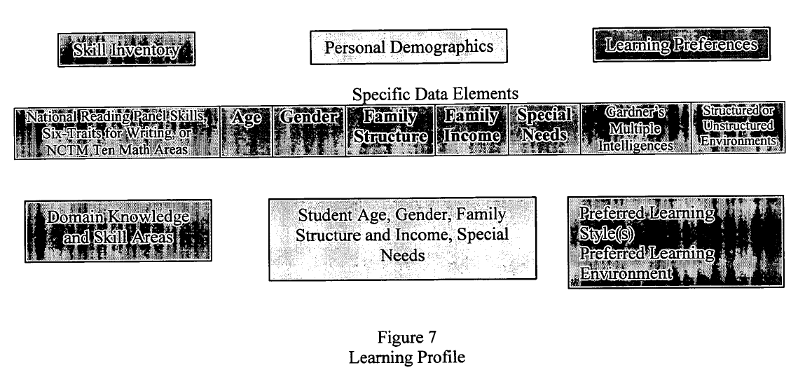

The AI Engine and the actions of the Agents drive the present invention curriculum. These systems use an array of student demographic, learning preference, and performance data, shown in FIG. 7, to make strategic decisions about the order and nature of instructional lessons to provide to each student. Personalization of the curriculum is achieved, in part, through the actions of these systems.

Students' demographic data include, for example, the student's age, enrolled grade, prior reading level, diagnosed special needs, family structure, income level, and type of community and school. Data about students' instructional preferences include their preferred learning style(s) and instructional structure. Further data includes information about the existing knowledge base of the child to support a cognitive model. These data are obtained from initial parent and teacher feedback, questionnaires, tests, preferences, hobbies, and experiences. As students interact with lessons, preference data are collected from the type of lessons the student easily masters or struggles to master. The teaching styles and structures, inherent in these lessons, are used to update the preference data for the students.

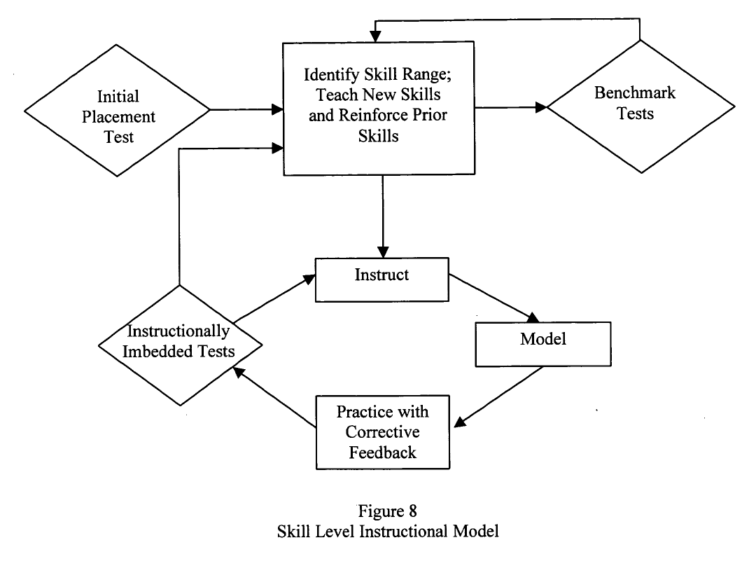

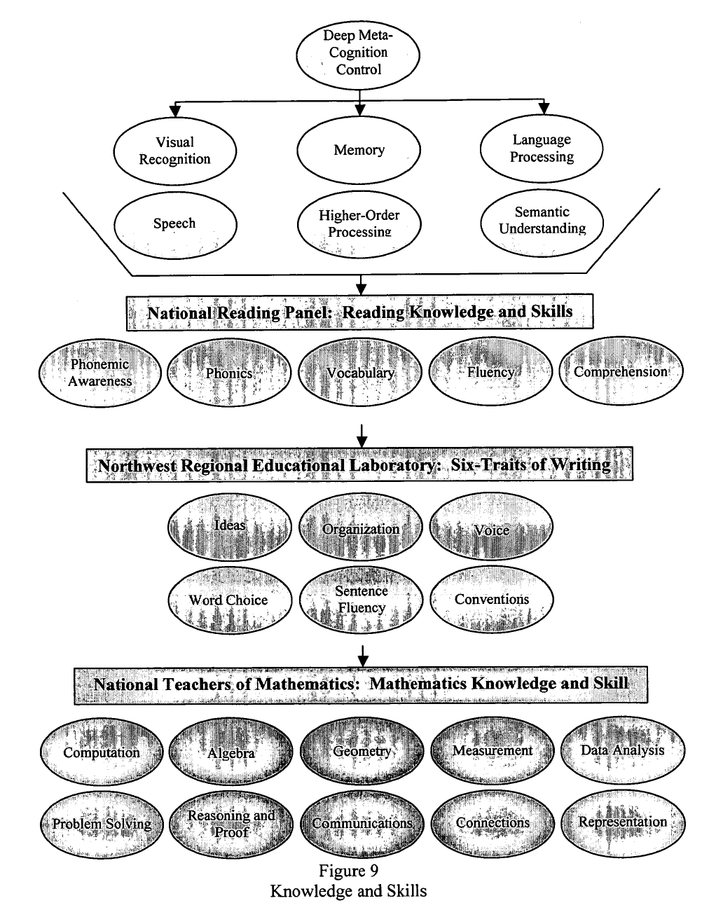

Student performance data are obtained from the assessment system that includes three levels of tests: The Initial Placement Test, Instructionally Imbedded Tests and Benchmark Tests, as shown in FIG. 8.

The Initial Placement Test provides placement of students into the curriculum and establishes a baseline for judging one-year growth in knowledge and skill performance. The Instructionally Imbedded tests provide information for guiding students through the curriculum at an appropriate rate, assuring mastery of foundation skills, and providing information for reporting student's progress. The Benchmark Tests provide post-test information for comparison with the initial placement information and the retention of mastery of knowledge and skills from the skill lessons.

The curriculum is taught in a flexible, sequential teaching strategy that allows students to move at their own developmental pace through the lessons. They advance ahead or repeat lessons based on their performance within the lessons. The assessment system is designed to support the flexible, sequential curriculum. The AI Engine and the Agents drive the optimal selection of lessons to obtain mastery of the desired knowledge and skills. Skill gaps and instructional sequences are determined for each child based on the instructional needs of the child and their learning preferences as deduced from the Student Cognitive Model.

Initial placement test

The initial placement test provides data to help place students in the appropriate levels of the curriculum and to identify the skill gaps that need to be addressed. To accomplish this and to keep the length of the assessment as short as possible, the assessment are constructed in two parts, a general placement and a specific knowledge skills assessment associated with the general placement. The general placement of each student is used to focus the second skills part of the test.

The AI Engine and Agent systems monitor the child's performance on the initial lessons to insure the appropriate placement of students in the curriculum. Students may need to be placed earlier in the instructional sequence if they are struggling with the first lesson. If they are doing well, they may need to advance to the next lesson. This monitoring helps further refine the initial placement of students in the curriculum.

Embedded tests

The skill lessons at each grade level include multiple learning tasks (game-like responses from students). These responses are monitored to determine the students' mastery of the lesson content. The performance of the students is used to determine when students move to the next lessons or when they receive additional instruction and skill practice. Where possible, the skill errors students make are tracked and specific practice and instruction is offered focusing on these errors.

Benchmark tests

Among the curriculum lessons, periodic benchmark tests are provided to assess the retention of critical scaffolding skills. These tests are used to identify persistent skill gaps and to assure that prerequisite skills are mastered prior to the instruction of higher-order skills. The benchmark tests include knowledge and skills that have been previously taught. Performance on the benchmark tests are compared and reported to document the learning gains attributable to instruction.

Critical Teaching Strategies

The instructional methods included in the curriculum generally follow the behavioral strategies suggested by Hunter (1991). The curriculum is built from a set of reading standards that reflects state and national standards, stated as behavioral knowledge and skills suggested by the research literature. The explicit instruction of skills includes modeling, guided practice, assessment, and extended practice if required for student mastery of the skills.

Three general teaching models are implemented in the Curriculum:

Skill-based instruction (modeling, practicing, assessing)

Task complexity instruction (sequence of increasingly complex tasks)

Project instruction (planning, execution, review, revision)

Skill acquisition is distributed throughout the curriculum. Pre-skills are introduced prior to explicit skill instruction and are reinforced through applications in new skill development activities. The specific instructional sequences for each level of the curriculum are outlined in the attachments, along with the specific curriculum standards.

The teaching strategies are guided by the AI Engine and the Agents to assure that the teaching methods contribute to the success of the students. Where possible, the student's preferences are employed to reinforce mastery of the specific lessons content. Recursive instruction, to address skill gaps, is used and modifications of instructional strategies are included in the decision rules used to guide such repetition. The AI Engine and the Agent systems are critical elements of the success of the instructional system.

Specific Embodiments

One embodiment of this invention is a system that delivers instruction to computers over a digital network such as the Internet. This includes instruction delivery to computers and handheld devices via wire and wireless means such as Ethernet and WiFi. This embodiment does not preclude the use of this invention in other networked and non-networked digital environments, nor delivery to alternative digital devices.

In this embodiment, functionality is implemented on both the student's computer or ‘Client’ and on the server computer or ‘Server’. The server contains all program code and data stored in permanent disk memory and program memory. The Server transfers program code and data to the Client as needed.

In the present embodiment the major components of the Server consist of a AI Engine, Learning Management System (LMS), Activities and Tests, Agents, web server, database storage, and the state of cognitive models.

The Client receives appropriate instructional material over the network for delivery to the student and sends results of the student's interaction with this material back to the Server.

The Learning Management System (LMS) authenticates students onto the system, assigns instructional lessons to them (based on information from the AI Engine), measures and saves responses, ensures the sequence of instruction is presented and completed correctly, and provides administrative reports of student progress. The LMS is also a Content Management System in that administrators may add or remove lesson content to and from the system in an easy way while the system provides revision and access control. The LMS also provides the User Interface or UI of lessons to the Student.

The Instructional Content is contained in Macromedia Flash-based ‘Activities’ which consist of 1 to several ‘Lessons’. Each Activity teaches a specific area of study while each Lesson focuses on different areas within this study area. The Flash Activities are uploaded to the Client computer where they are executed using a local Flash ‘Player’ This reduces the load on the server since the resource heavy Activities, featuring animations and complex interactions, are run entirely on the Client, the Server simply has to upload the Flash Device as a binary file to the Client. While the Client executes the Lessons in an Activity however, each Lesson communicates back to the Server about progress and other result events.

The state of the Agents is always maintained on the Server even though oftentimes they are executing on the Client. Each instructional Activity has its own Content Agent to interface between the student and the functionality of the Activity, and to also interface with the Learning Management System. The Content Agents are in fact experts about the instructional material of their particular Activity and contribute to the corresponding Student Cognitive Model components. In addition, the Helper Agent manages all of the Content Agents. It is the Helper Agent who immediately controls the system in not only managing Agent-input to the Student Cognitive Model but also ongoing input to the Student Cognitive Model from the AI Engine.

The AI Engine is a large component of the web server system and is a dedicated server in its own right. The AI requirements of the system are computational heavy and the dataset is large. For this reason the classifier output of AI Engine is only generated infrequently. Existing classifications are immediately available to the system to apply to new students. The information from the AI Engine is used by the LMS to initially assign lessons to students.

Operation

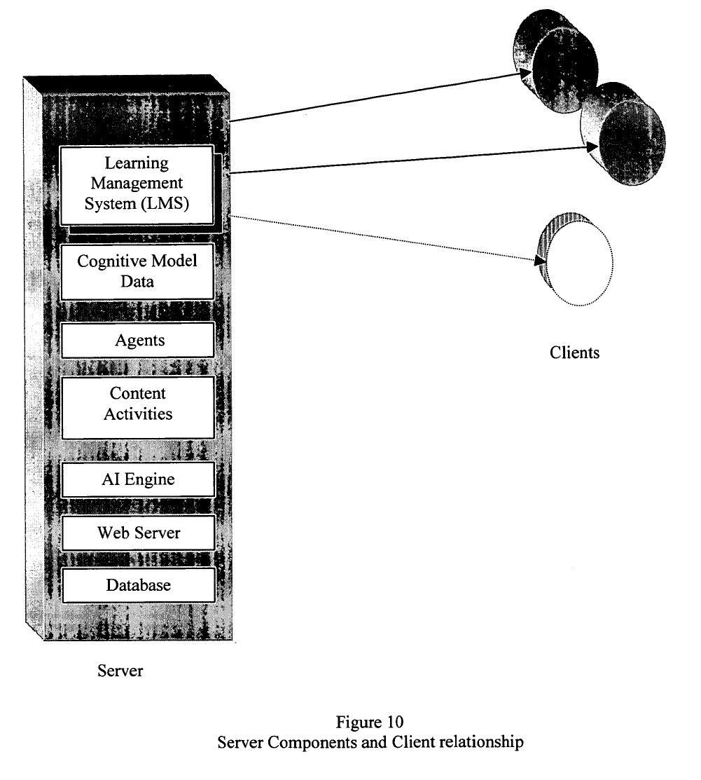

As shown in FIG. 10, a single Server can service multiple “Clients”. The Clients are the end-user student computers located at home or at an institution such as a school. The Server(s) is located as the company's facilities or an Independent Service Provider (ISP). The Server works in the background and is normally not physically seen by the student.

The parent or guardian of the student first browses to the online purchase area of the Server and during this process enters background information about the student. This information is used to populate the prior knowledge Student Cognitive Model of the student. Teachers may also enter information in this location. The information gathered includes the interests of the child, experiences they have had—games they play, movies they've watched, stories they are familiar with, people they know, television programs that they watch, their likes and dislike. This information also includes information about the family such as native language, learning issues with other family members, and educational history. Direct information about the child such as age, grade, sex, spoken language, currently estimated education level, and dyslexia-screening question results, are also entered at this point. All of this information is used to populate the cognitive state of the Student Cognitive Model.

The first experience the student has with the system is to identify further interests that they personally relate to. A dynamically adaptable test is also given to the student that directly assesses their current competence in the targeted area of study such as reading, mathematics, and science. This information is also used to populate the cognitive components of the Student Cognitive Model. The parent/teacher also receives an online assessment of the results of the student test, and further recommendations, should issues such as the potential for dyslexia be identified.

The Server side AI Engine now patterns the new student cognitive model against the cognitive models of all existing students to predict the best course of study for that particular student. Using an AI Engine means that perfect matches do not need to be made to the extent that the AI Engine may generate a new course combination that has never been recommended before. This customized program of study is then sent to the parent/teacher or guardian and the student may begin the program.

An important component of the customized program of study are the Agents. These software Agents provide ongoing help and guidance to the student and have a visual component that appears as animated characters. The Agents have access to the Student Cognitive Model as initially communicated from the Server-side AI Engine when the customized program for the student is first acquired by the parent/teacher or guardian. There are two main classes of Agents: the “Helper” Agent, and the “Content” Agents. The Helper Agent acts as a single guide and accompanies the student throughout the entire program by recommending paths, making introductions to other Agents, taking a break from the program, answering questions, providing encouraging feedback, and acting as a companion to the student. The Helper Agent is not a content domain expert in themselves but they know where the content information is located. The Helper Agent may contain a voice recognition system where the student may speak questions and instructions to the Agent. The Agent mostly communicates to the student by visual and auditory means.

The “Content” Agents are located at each different area of content, or skill area, know as an Activity. It is the Helper Agent that navigates the student to the various content activities where the Content Agents reside. Unlike the Helper Agent, the Content Agents are experts in their subject domain. These Agents are aware of the predicted course of study for the student and are constantly evaluating this predication based on student responses to the lesson material. Should student responses align with the prediction then the predication value is strengthened, should the student responses not align with the prediction then it is modified based on the Student Cognitive Model. The Content Agent introduces the subject matter, instructs the student on required background knowledge, demonstrates how the student should operate the game-like Activity, and acts as an expert to answer questions or offer help when the student requires it. The Content Agents communicate with one another and the Helper Agent through information in the Student Cognitive Model.

The content Activities are fun, highly animated game-like exercises that focus on a particular skill, or area of study. These Activities are also adaptive in that they monitor how the student progresses and make adjustments accordingly. This information is communicated to the Helper Agent who then updates the Student Cognitive Model with new information about the Student. The Helper Agent also takes action based on the newly updated cognitive model. For example, if the student struggles in a particular Activity then the Activity itself will first implement internal changes to adapt to the student. If the problem goes beyond the scope of the Activity then the Helper Agent, in conjunction with the Student Cognitive Model, will adapt at the Activity level to redirect the student to less difficult material, revisit an Activity with new material, or direct the student to a similar Activity using an alternative learning style for example. Likewise if the student does particularly well in an Activity outside of its scope then the Helper Agent may direct the Student to more challenging activities. It is important to note that the Helper Agent can draw on information in the Study Cognitive Model, which in turn has been initially predicted and created by the AI Engine. For example, student progress might indicate that the student is mastering the material and that the child should be moved to more challenging material. However, upon consulting the Student Cognitive Model the Helper Agent may discover that information patterned from the AI Engine indicates that past experience has shown that this particular student is probably too young to warrant this change, so an alternative activity, with perhaps more focus on a different area of study is given.

At this point it can be seen how the Server side AI Engine initially predicts a best course of study for the student based on an AI pattern of their cognitive model with cognitive models of a previous population of students. The AI engine then recommends an initial program that it has found to be historically the most successful for this Student Cognitive Model. Once the student begins the program the Agents then take over the role of dynamically refining the cognitive model and adapting the program to the needs of the student. In addition to information about the student's progress and responses received from the Activities to the Helper Agent, the Activities themselves also contain specific embedded tests to assess how well the child is doing. This further helps to refine the Student Cognitive Model on an ongoing basis.

As the student progresses though the program the Agents further refine the Student Cognitive Model that in turn continually adapts the content material to the student. By using the program this way the system “learns” more and more about the best techniques and strategies that work with each individual student. This information is also communicated back to the AI Engine where it is added to the pool of past student population histories thus further refining the model for future students. As more and more students pass though the system it can more accurately predict what the best initial program of study is, and what the best action to take on a going basis should be. The results are that the student learns in an environment that builds on the knowledge they already have by integrating new information with this knowledge. These connections are then strengthened in specifically designed Activities to ensure that real learning has occurred. Similarly, other Activities measure the ability of the student to recall this information in a meaningful and useful way so that the new information becomes integrated into what the student already knows. It is at this stage the student has “learned” the new information.

We claim as our invention:

1. A method of ensuring that students learn from instruction, comprising the steps of:
acquiring cognitive student data into a computer;
storing cognitive student data models in a computer;
automatically creating a customized program of content activities based on a student cognitive model; and
automatically adjusting a customized program of activities based on a changing student cognitive model as said student progresses through the program

2. The method of claim 1, wherein acquiring cognitive student data step is the input of prior knowledge from familiar sources and directly from student

3. The method of claim 1, wherein the computer has an Artificial Intelligence Engine to automatically create a customized program of activities step

4. The method of claim 1, wherein the automatic adjustment of the customized program of activities step is implemented by software agents

5. The method of claim 1, wherein a customized program of activities is managed by a helper agent and a plurality of content agents

6. The method of claim 3, wherein the automatic creating of a customized program step further comprises the step of pattern matching the target students individual cognitive model with the historically stored cognitive model of all previous students using an Artificial Intelligence Engine

7. The method of claim 5, wherein the agent further comprises a helper agent to guide and encourage the student, and multiple content agents to present instructional material.

8. The method of claim 5, wherein automatic adjusting of the student cognitive model is implemented by the helper agent and the content agents monitoring student responses to customized program of activities.

9. The method of claim 8 wherein the helper agent and the multitude of contents agents communicate with the student via computer response, voice recognition and speech.

10. A computer-implemented learning system, comprising:
a server computer and a plurality of client computers on a network
means for displaying a prior knowledge questionnaire and test to a parent/guardian/teacher and student on a client computer, and storing said results in a student cognitive model dataset
means for storing a student cognitive model in a server computer
means for comparing a multitude of stored student cognitive models with a new student cognitive model using an Artificial Intelligence Engine for the purpose of identifying pattern matches of past successful activity programs
means for downloading and implementing software helper and content agents on a client computer
means for downloaded and visually presenting content activities to a student on a client computer
means for student to interact with content activities and to have said interactions stored
means for communications between a server AI Engine and client software agents

11. The apparatus of claim 10, further comprising a means to modify a student cognitive model according to the student's results

12. The apparatus of claim 10, further comprising a means to hear student directions and questions using voice recognition and a means to instruct the student using speech.

13. The apparatus of claim 10, further comprising means of providing parents/guardians/teachers with reports based on student interactions with content activities.

14. The apparatus of claim 10, further comprising a mechanism to allow students to accumulate rewards in the form of points based on their results of mastering content activities.
